(19) United States
(12) Patent Application Publication
(10) Pub. No.: US 2023/0194042 A1
(43) Pub. Date: Jun. 22, 2023

(54) Quick Release Mounting Adaptor

(71) Applicant: Fan Jun Liu, Vancouver (CA)

(72) Inventor: Fan Jun Liu, Vancouver (CA)

(21) Appl. No.: 18/169,608

(22) Filed: Feb. 15, 2023

Related U.S. Application Data
(63) Continuation-in-part of application No. 17/948,131, filed on Sep. 19, 2022.
(60) Provisional application No. 63/223,470, filed on Jul. 19, 2021.

(51) Int. Cl. F16M 11/16

(52) U.S. Cl. CPC F16M 11/16

(57) ABSTRACT

A quick release mounting adaptor includes a mounting adaptor and a head screw. The mounting adaptor that attaches to a tripod or monopod includes a main body, a threaded opening, and a quick release female coupler. The head screw that attaches to a device includes a threaded shaft and a quick release male coupler. The threaded opening concentrically traverses into the main body. The quick release female coupler is concentrically integrated into the main body. The threaded opening and the quick release female coupler are oppositely positioned of each other about the main body. The threaded shaft and the quick release male coupler are adjacently connected to each other. The head screw is compressionally attached to the mounting adaptor through the quick release male coupler and the quick release female coupler as the threaded shaft attaches with the device and the threaded opening attaches with the tripod or monopod.

The current application is a continuation-in-part (CIP) application of a U.S. non-provisional application Ser. No. 17/948,131 filed on Sep. 19, 2022. The U.S. non-provisional application Ser. No. 17/948,131 claims a priority to a U.S. provisional application Ser. No. 63/223,470 filed on Jul. 19, 2021. The U.S. provisional patent application 63/223,470 is revived within the two-month period for unintentional abandonment by Sep. 19, 2022.

### FIELD OF THE INVENTION

The present invention relates generally to hunting and photo equipment mount. More specifically, the present invention allows for easy change for different type of devices using the same tripod or monopod.

### BACKGROUND OF THE INVENTION

A tripod is a portable three-legged frame or stand, used as a platform for supporting the weight and maintaining the stability of some other object. Generally, a tripod is used to support and stabilize devices such as photo equipment, cameras, hunting equipment, sound equipment, or any other types of devices that need to be placed at an elevated position. The three-legged (triangular stance) design of the tripod provides good stability against gravitational loads as well as horizontal shear forces, and better leverage for resisting tipping over due to lateral forces can be achieved by spreading the legs away from the vertical center. Even though the term “tripod” is commonly used within the industry for the device stand, similar functionality can be achieved from variations with one, two, and four legs stands that are termed monopod, bipod, and quadripod. The devices are attached to the tripod through a mounting head, which typically requires a screw or similar hardware connection piece to fasten the two components together. However, traditional threaded attachment between the device and the tripod can be problematic as the devices can be accidently dropped and damaged during the mounting process.

It is an objective of the present invention to provide a quick release mounting adaptor that can streamline the mounting process between the tripod and the device. The present invention is mounted onto the tripod so that the user can simply apply pressure to a sliding actuator to disengage or engage the device. The present invention is able to eliminate twisting process of the device that is generally associated with the screw mounting process thus improving the safety and health of the device during the mounting process.

### BRIEF DESCRIPTION OF THE DRAWINGS

FIG. 1 is a top perspective view of the present invention.

FIG. 2 is a top perspective view of the mounting adaptor of the present invention.

FIG. 3 is a side view of the mounting adaptor of the present invention without the release actuator and the spring.

FIG. 4 is a cross section view of the mounting adaptor without the release actuator and the spring taken along line 4-4 in FIG. 3.

FIG. 5 is a side view of the mounting adaptor of the present invention.

FIG. 6 is a cross section view of the mounting adaptor taken along line 6-6 in FIG. 5.

FIG. 7 is a side view of the release actuator of the present invention.

FIG. 8 is a side view of the head screw of the present invention.

FIG. 9 is a schematic view showing the attachment between the mounting adaptor and the head screw.

FIG. 10 is a schematic view showing the removal of the head screw from the mounting adaptor.

### DETAIL DESCRIPTIONS OF THE INVENTION

All illustrations of the drawings are for the purpose of describing selected versions of the present invention and are not intended to limit the scope of the present invention.

The present invention is a quick release mounting adaptor 1 that can ease the mounting process between a tripod and a device. The present invention eliminates the twist-attachment process of the device that is generally associated with the tripod thus protecting the device from damages and accidental dropping. Due to the quick release attachment of the present invention, the user is able to easily mount or remove the device from the tripod. Even though the term “tripod” is utilized herein after as the stand that stabilizes the device at an elevated height, it is understood that the same functionality can be achieved by monopod, bipod, and quadripod. The device explained hereinafter can include, but not limited to, photo equipment, cameras, hunting equipment, sound equipment, or any other types of devices that need to be placed at an elevated position.

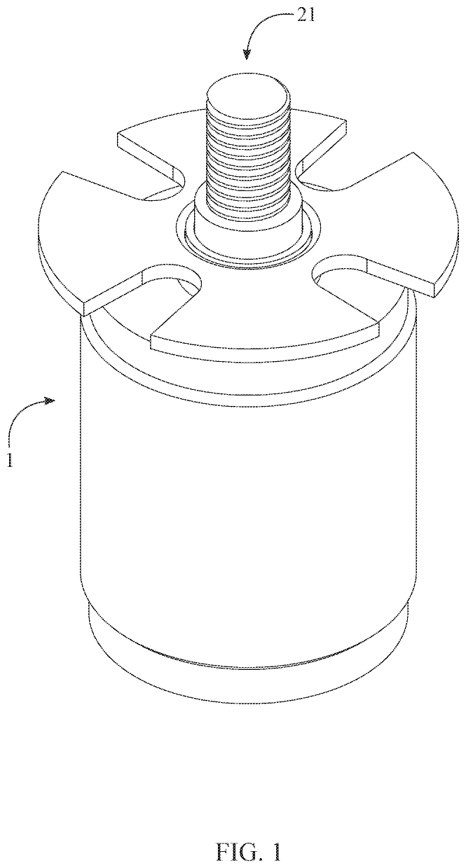

As shown in FIG. 1, the present invention comprises a mounting adaptor 1 and a head screw 21. In reference to the general configuration of the present, the mounting adaptor 1 is screwed into a mounting screw of the tripod. The head screw 21 is screwed into an existing mounting hole of the device. Resultantly, the user is able to easily mount the device to the tripod or remove the device from the tripod as the head screw 21 engages with the mounting adaptor 1 similar to a quick release locking mechanism.

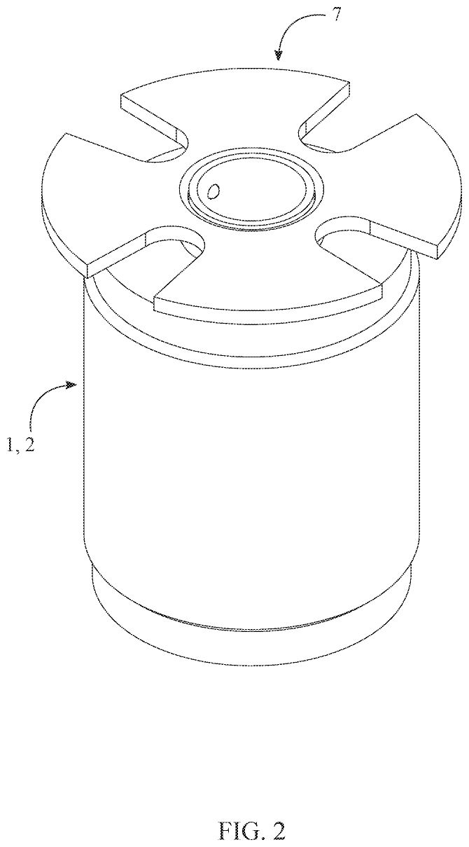

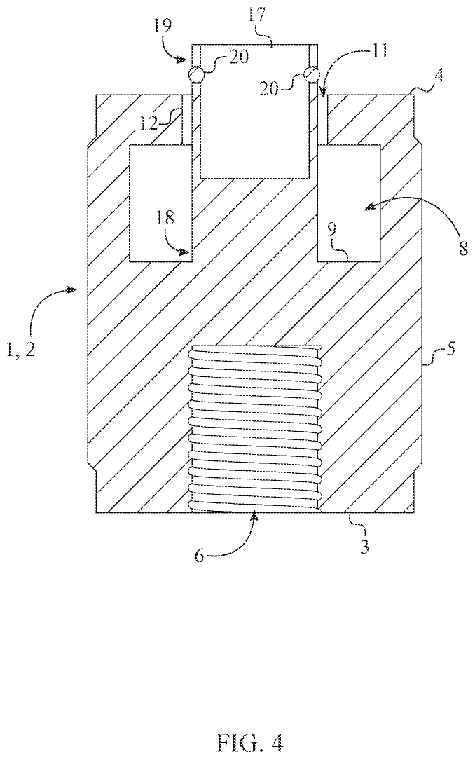

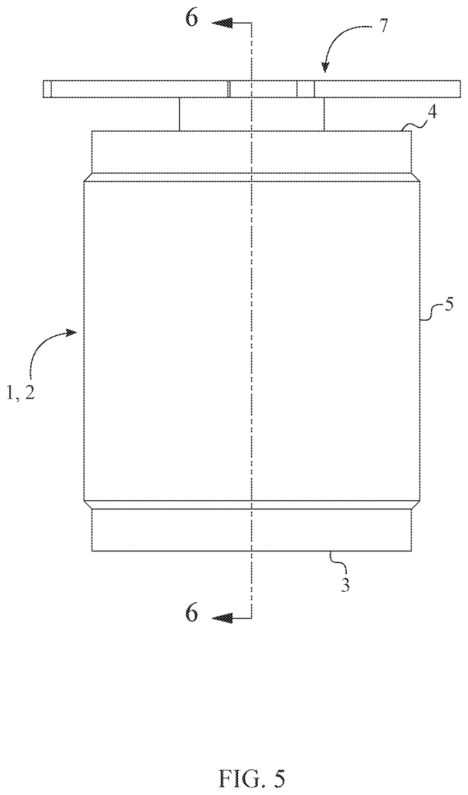

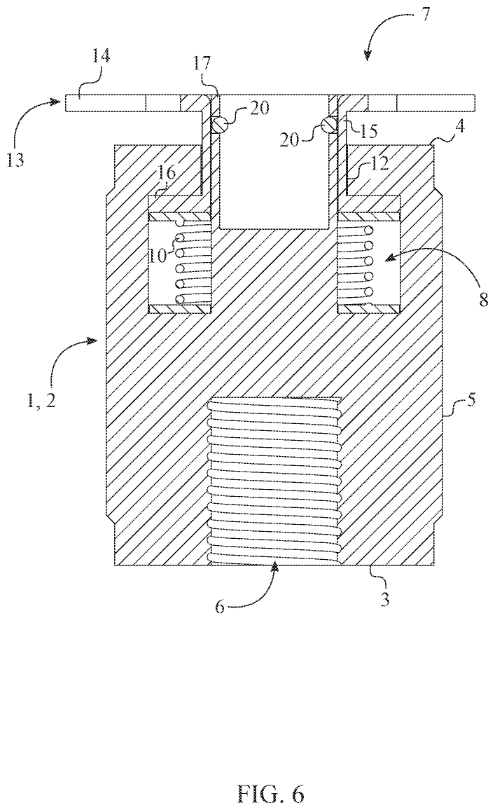

In reference to FIGS. 2-6, the mounting adaptor 1 that attaches to the tripod comprises a main body 2, a threaded opening 6, and a quick release female coupler 7. The main body 2 is formed into a cylindrical shape and a bottom surface 3, a top surface 4, and a lateral surface 5. More specifically, the top surface 4 and the bottom surface 3 are oppositely positioned of each other about the lateral surface 5 as the main body 2 extends from the bottom surface 3 to the top surface 4. The lateral surface 5 is integrated with a fiction enhancing layer or features so that the user can easily grasp the main body 2. The top surface 4 and the bottom surface 3 are positioned parallel to each other shaped as a flat surface area. The threaded opening 6 concentrically traverses into the main body 2 and threadedly engages with the mounting screw of the tripod. In other words, the threaded opening 6 concentrically traverses into the main body 2 from the bottom surface 3 so that the flat surface area of the bottom surface 3 can firmly stabilize on top of the tripod. The quick release female coupler 7 is concentrically integrated into the main body 2 to engaged with the head screw 21. The quick release female coupler 7 is concentrically integrated into the main body 2 through the top surface 4, wherein the quick release female coupler 7 and the threaded opening 6 are oppositely positioned of each other about the main body 2. Due to the flat surface area of the top surface 4, the device can be firmly stabilized on top of the main body 2.

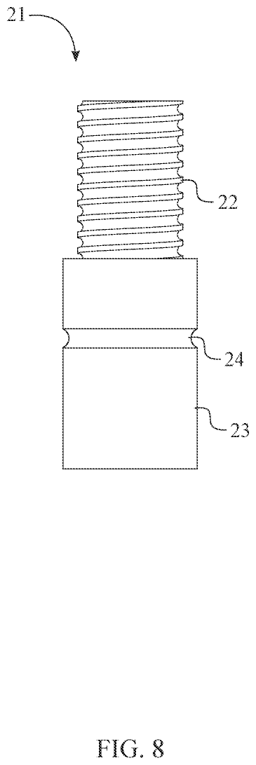

In reference to FIG. 8, the head screw 21 is formed into a cylindrical shape and comprises a threaded shaft 22 and a quick release male coupler 23. The threaded shaft 22 and the quick release male coupler 23 are adjacently connected to each other so that the head screw 21 can function as the intermediate fastener between the mounting adaptor 1 and the device. More specifically, the threaded shaft 22 is designed to threadedly engaged with the existing mounting hole of the device. The quick release male coupler 23 is designed to compressionally engaged with the mounting adaptor 1.

As shown in FIG. 1, in order to attach the head screw 21 into the mounting adaptor 1, the quick release male coupler 23 is concentrically positioned with the quick release female coupler 7 so that the head screw 21 can be compressionally attached to the mounting adaptor 1 through the quick release male coupler 23 and the quick release female coupler 7. Due to the aforementioned attachment, the threaded shaft 22 is outwardly oriented from the main body 2.

In reference to FIG. 8, the head screw 21 may further comprise a radial groove 24 so that the attachment between the quick release male coupler 23 and the quick release female coupler 7 can be optimized. More specifically, the radial groove 24 laterally traverses into the quick release male coupler 23 and positioned offset from the threaded shaft 22. The functionality of the radial groove 24 is explained with respect to the subcomponents of the quick release female coupler 7 herein after.

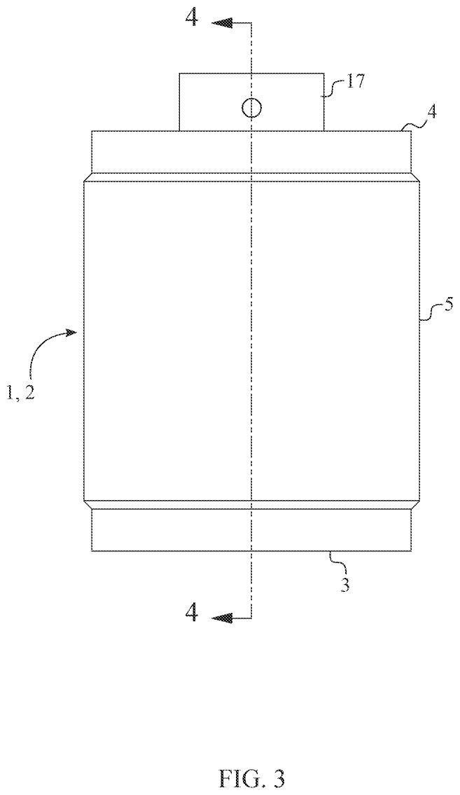

In reference to FIG. 2 and FIG. 3, the quick release female coupler 7 may comprise a spring enclosure 8, a spring 10, a channel 11, a release actuator 13, a hollow shaft 17, and at least one detent ball 20. More specifically, the spring enclosure 8 is positioned within the main body 2 as the spring enclosure 8 and the threaded opening 6 are positioned opposite of each other. The channel 11 concentrically traverses into the spring enclosure 8 from the top surface 4 of the main body 2. In other words, the channel 11 provides a pathway from the top surface 4 to the spring enclosure 8 through the main body 2. The hollow shaft 17 is concentrically positioned within the channel 11 and provides sufficient tolerance to receive the quick release male coupler 23. More specifically, a fixed end 18 of the hollow shaft 17 is terminally connected to a base 9 of the spring enclosure 8. A free end 19 the hollow shaft 17 is outwardly extended from the top surface 4 through the channel 11. The release actuator 13 is slidably engaged around the hollow shaft 17 and functions as an actuating body that locks and unlocks the head screw 21. The spring 10 is positioned within the spring enclosure 8 and concentrically positioned around the hollow shaft 17. The release actuator 13 is compressionally positioned adjacent to the spring 10 so that the spring 10 compression is able to apply upward pressure to the release actuator 13. The at least one detent ball 20 is slidably engaged through the hollow shaft 17 and externally positioned to the top surface 4. The at least one detent ball 20 corresponds to the radial groove 24 so that the quick release male coupler 23 can be secured within the hollow shaft 17.

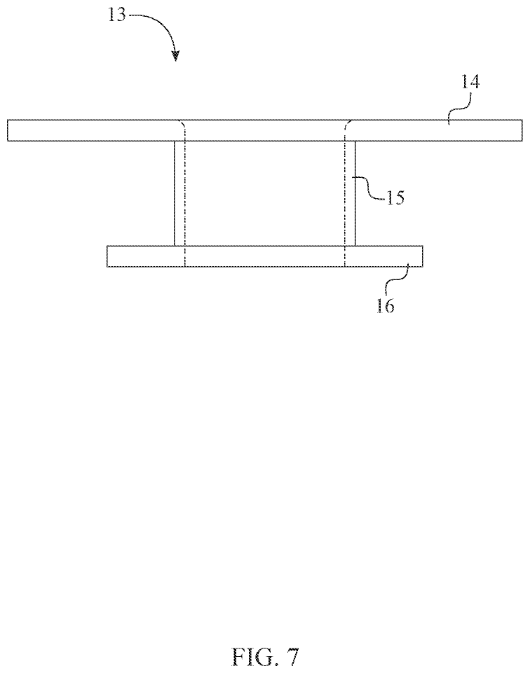

In reference to FIG. 7, the release actuator 13 may comprise a pressure-receiving plate 14, a tubular connector 15, and a pressure-applying plate 16. More specifically, the tubular connector 15 is radially interposed between a lateral wall 12 of the channel 11 and the hollow shaft 17 so that the tubular connector 15 is able to easily slide up and down in between the channel 11 and the hollow shaft 17. The pressure-receiving plate 14 and the pressure-applying plate 16 are oppositely positioned of each other about the tubular connector 15. The pressure-receiving plate 14 is perimetrically connected around the tubular connector 15 so that the user can apply downward pressure onto the release actuator 13 via the pressure-receiving plate 14. Since the pressure-receiving plate 14 is outwardly extended from the tubular connector 15, the pressure-receiving plate 14 does not limit the movement of the release actuator 13. The pressure-applying plate 16 is perimetrically connected around the tubular connector 15 so that the downward pressure from the pressure-receiving plate 14 can be transferred into the pressure-applying plate 16 via the tubular connector 15. Since the pressure-applying plate 16 is outwardly extended from the tubular connector 15, the pressure-applying plate 16 does not limit the movement of the release actuator 13. Furthermore, the pressure-receiving plate 14 is externally positioned to the top surface 4 so that the user can easily apply the downward pressure. The pressure-applying plate 16 is compressionally engaged with the spring 10 so that the release actuator 13 can be returned to a natural position once the downward pressure is released from the pressure-receiving plate 14.

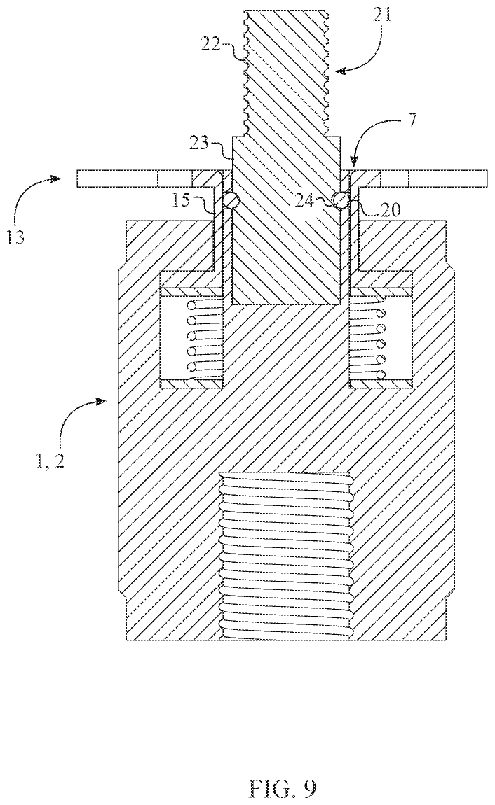

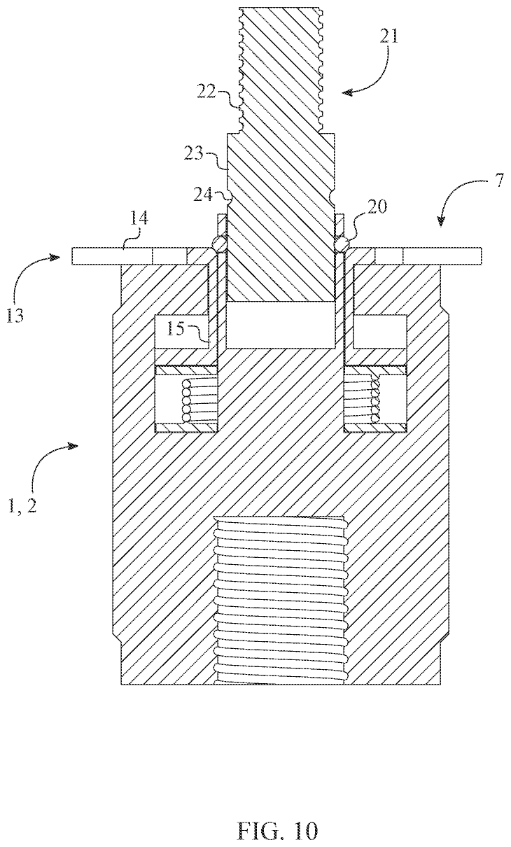

In reference to FIG. 9 and FIG. 10, when the present invention is at the natural position, the pressure-applying plate 16 is compressed between a ceiling of the spring enclosure 8 due to the compressional force of the spring 10. At the same time, the tubular connector 15 encloses the at least one detent ball 20 thus applying an inward radial force. As a result, the at least one detent ball 20 moves toward a central axis of the mounting adaptor 1. When the downward pressure is applied to the pressure-receiving plate 14 by the user, the release actuator 13 slides down into the spring enclosure 8 along the hollow shaft 17 thus further compressing the spring 10 through the pressure-applying plate 16. Once the pressure-receiving plate 14 is positioned adjacent and against the top surface 4, the tubular connector 15 moves below the at least one detent ball 20 thus allowing the at least one detent ball 20 to move into a neutral position. Then, the quick release male coupler 23 can be inserted into the hollow shaft 17 as the at least one detent ball 20 freely moves away from the central axis of the mounting adaptor 1 by an outer surface of the quick release male coupler 23. When the quick release male coupler 23 is fully inserted into and engaged within the hollow shaft 17, the at least one detent ball 20 is positioned adjacent to the radial groove 24. Releasing of the downward pressure from the pressure-receiving plate 14 allows the present invention to return back to the natural position. As a result, the release actuator 13 slides upward from the spring enclosure 8 along the hollow shaft 17 due to the compressional force of the spring 10. Simultaneously, the tubular connector 15 applies an inward radial force to the at least one detent ball 20 thus engaging the at least one detent ball 20 with the radial groove 24. Once the pressure-receiving plate 14 is positioned offset from the top surface 4 and the pressure-applying plate 16 is compressed against the ceiling of the spring enclosure 8, the at least one detent ball 20 is compressionally positioned adjacent to the tubular connector 15 and engaged within the radial groove 24 further strengthening the attachment between the mounting adaptor 1 and the head screw 21.

Although the invention has been explained in relation to its preferred embodiment, it is to be understood that many other possible modifications and variations can be made without departing from the spirit and scope of the invention as hereinafter claimed.

What is claimed is:

1. A quick release mounting adaptor comprising:
a mounting adaptor;
a head screw;
the mounting adaptor comprising a main body, a threaded opening, and a quick release female coupler;
the head screw comprising a threaded shaft and a quick release male coupler;
the threaded opening concentrically traversing into the main body;
the quick release female coupler being concentrically integrated into the main body;
the quick release female coupler and the threaded opening being oppositely positioned of each other about the main body;
the threaded shaft and the quick release male coupler being adjacently connected to each other;
the quick release male coupler being concentrically positioned with the quick release female coupler;
the head screw being compressionally attached to the mounting adaptor through the quick release male coupler and the quick release female coupler; and
the threaded shaft being outwardly oriented from the main body.

2. The quick release mounting adaptor as claimed in claim 1 comprising:
the main body comprising a bottom surface, a top surface, and a lateral surface;
the top surface and the bottom surface being oppositely positioned of each other about the lateral surface;
the threaded opening concentrically traversing into the main body from the bottom surface; and
the quick release female coupler being concentrically integrated into the main body through the top surface.

3. The quick release mounting adaptor as claimed in claim 1 comprising:
the head screw further comprising a radial groove;
the radial groove being laterally traversing into the quick release male coupler; and
the radial groove being positioned offset from the threaded shaft.

4. The quick release mounting adaptor as claimed in claim 1 comprising:
the quick release female coupler comprising a spring enclosure, a spring, a channel, a release actuator, a hollow shaft, and at least one detent ball;
the spring enclosure being positioned within the main body;
the spring enclosure and the threaded opening being positioned opposite of each other;
the channel concentrically traversing into the spring enclosure from a top surface of the main body;
the hollow shaft being concentrically positioned within the channel;
a fixed end of the hollow shaft being terminally connected to a base of the spring enclosure;
a free end the hollow shaft being outwardly extended from the top surface;
the release actuator being slidably engaged around the hollow shaft;
the spring being positioned within the spring enclosure;
the spring being concentrically positioned around the hollow shaft;
the release actuator being compressionally positioned adjacent to the spring;
the at least one detent ball being slidably engaged through the hollow shaft; and
the at least one detent ball being externally positioned to the top surface.

5. The quick release mounting adaptor as claimed in claim 4 comprising:
the release actuator comprising a pressure-receiving plate, a tubular connector, and a pressure-applying plate;
the tubular connector being radially interposed between a lateral wall of the channel and the hollow shaft;
the pressure-receiving plate and the pressure-applying plate being oppositely positioned of each other about the tubular connector;
the pressure-receiving plate being perimetrically connected around the tubular connector;
the pressure-applying plate being perimetrically connected around the tubular connector;
the pressure-receiving plate being externally positioned to the top surface; and
the pressure-applying plate being compressionally engaged with the spring.

6. The quick release mounting adaptor as claimed in claim 4 comprising:
the at least one detent ball being compressionally positioned adjacent to a tubular connector of the release actuator; and
the at least one detent ball being engaged with a radial groove of the head screw.

7. A quick release mounting adaptor comprising:
a mounting adaptor;
a head screw;
the mounting adaptor comprising a main body, a threaded opening, and a quick release female coupler;
the head screw comprising a threaded shaft, a quick release male coupler, and a radial groove;
the threaded opening concentrically traversing into the main body;
the quick release female coupler being concentrically integrated into the main body;
the quick release female coupler and the threaded opening being oppositely positioned of each other about the main body;
the threaded shaft and the quick release male coupler being adjacently connected to each other;
the radial groove being laterally traversing into the quick release male coupler;
the radial groove being positioned offset from the threaded shaft;
the quick release male coupler being concentrically positioned with the quick release female coupler;
the head screw being compressionally attached to the mounting adaptor through the quick release male coupler and the quick release female coupler; and
the threaded shaft being outwardly oriented from the main body.

8. The quick release mounting adaptor as claimed in claim 7 comprising:
the main body comprising a bottom surface, a top surface, and a lateral surface;
the top surface and the bottom surface being oppositely positioned of each other about the lateral surface;
the threaded opening concentrically traversing into the main body from the bottom surface; and
the quick release female coupler being concentrically integrated into the main body through the top surface.

9. The quick release mounting adaptor as claimed in claim 7 comprising:
the quick release female coupler comprising a spring enclosure, a spring, a channel, a release actuator, a hollow shaft, and at least one detent ball;
the spring enclosure being positioned within the main body;
the spring enclosure and the threaded opening being positioned opposite of each other;
the channel concentrically traversing into the spring enclosure from a top surface of the main body;
the hollow shaft being concentrically positioned within the channel;
a fixed end of the hollow shaft being terminally connected to a base of the spring enclosure;
a free end the hollow shaft being outwardly extended from the top surface;
the release actuator being slidably engaged around the hollow shaft;
the spring being positioned within the spring enclosure;
the spring being concentrically positioned around the hollow shaft;
the release actuator being compressionally positioned adjacent to the spring;
the at least one detent ball being slidably engaged through the hollow shaft; and
the at least one detent ball being externally positioned to the top surface.

10. The quick release mounting adaptor as claimed in claim 9 comprising:
the release actuator comprising a pressure-receiving plate, a tubular connector, and a pressure-applying plate;
the tubular connector being radially interposed between a lateral wall of the channel and the hollow shaft;
the pressure-receiving plate and the pressure-applying plate being oppositely positioned of each other about the tubular connector;
the pressure-receiving plate being perimetrically connected around the tubular connector;
the pressure-applying plate being perimetrically connected around the tubular connector;
the pressure-receiving plate being externally positioned to the top surface; and
the pressure-applying plate being compressionally engaged with the spring.

11. The quick release mounting adaptor as claimed in claim 9 comprising:
the at least one detent ball being compressionally positioned adjacent to a tubular connector of the release actuator; and
the at least one detent ball being engaged with the radial groove of the head screw.

12. A quick release mounting adaptor comprising:
a mounting adaptor;
a head screw;
the mounting adaptor comprising a main body, a threaded opening, and a quick release female coupler;
the head screw comprising a threaded shaft, a quick release male coupler, and a radial groove;
the quick release female coupler comprising a release actuator and at least one detent ball;
the threaded opening concentrically traversing into the main body;
the quick release female coupler being concentrically integrated into the main body;
the quick release female coupler and the threaded opening being oppositely positioned of each other about the main body;
the threaded shaft and the quick release male coupler being adjacently connected to each other;
the radial groove being laterally traversing into the quick release male coupler;
the radial groove being positioned offset from the threaded shaft;
the quick release male coupler being concentrically positioned with the quick release female coupler;
the head screw being compressionally attached to the mounting adaptor through the quick release male coupler and the quick release female coupler;
the threaded shaft being outwardly oriented from the main body;
the at least one detent ball being compressionally positioned adjacent to a tubular connector of the release actuator; and
the at least one detent ball being engaged with the radial groove of the head screw.

13. The quick release mounting adaptor as claimed in claim 12 comprising:
the main body comprising a bottom surface, a top surface, and a lateral surface;
the top surface and the bottom surface being oppositely positioned of each other about the lateral surface;
the threaded opening concentrically traversing into the main body from the bottom surface; and
the quick release female coupler being concentrically integrated into the main body through the top surface.

14. The quick release mounting adaptor as claimed in claim 12 comprising:
the quick release female coupler comprising a spring enclosure, a spring, a channel, and a hollow shaft;
the spring enclosure being positioned within the main body;
the spring enclosure and the threaded opening being positioned opposite of each other;
the channel concentrically traversing into the spring enclosure from a top surface of the main body;
the hollow shaft being concentrically positioned within the channel;
a fixed end of the hollow shaft being terminally connected to a base of the spring enclosure;
a free end the hollow shaft being outwardly extended from the top surface;
the release actuator being slidably engaged around the hollow shaft;
the spring being positioned within the spring enclosure;
the spring being concentrically positioned around the hollow shaft;
the release actuator being compressionally positioned adjacent to the spring;
the at least one detent ball being slidably engaged through the hollow shaft; and
the at least one detent ball being externally positioned to the top surface.

15. The quick release mounting adaptor as claimed in claim 14 comprising:
the release actuator comprising a pressure-receiving plate, a tubular connector, and a pressure-applying plate;
the tubular connector being radially interposed between a lateral wall of the channel and the hollow shaft;
the pressure-receiving plate and the pressure-applying plate being oppositely positioned of each other about the tubular connector;
the pressure-receiving plate being perimetrically connected around the tubular connector;
the pressure-applying plate being perimetrically connected around the tubular connector;
the pressure-receiving plate being externally positioned to the top surface; and
the pressure-applying plate being compressionally engaged with the spring.
